(19) United States
(12) Patent Application Publication
(10) Pub. No.: US 2005/0181197 A1
(43) Pub. Date: Aug. 18, 2005

(54) Porous ceramic sintered body for slidable member, manufacturing method thereof, and seal ring

(75) Inventors: Shinichiro Masuyama, Kokubu-shi (JP); Takeshi Hara, Kokubu-shi (JP); Kazuki Oshima, Kokubu-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/014,215

(22) Filed: Dec. 16, 2004

(30) Foreign Application Priority Data
Dec. 17, 2003 (JP) 2003-420163

(51) Int. Cl. C04B 35/565

(52) U.S. Cl. 428/304.4; 501/81; 501/88; 264/43; 264/682

(57) ABSTRACT

A porous ceramic sintered body for slidable member, which has a mean pore diameter of 20 to 39 μm, and a porosity over 13.0 volume % and not more than 18.0 volume %, can be obtained by: forming bubbles by removing organic matter from a ceramic green body containing ceramic powder, forming aid, and pore forming material which is resin beads selected from suspension-polymerized non-cross-linked polystyrene and suspension-polymerized non-cross-linked styrene-acryl copolymer; followed by heating and sintering. The porous ceramic sintered body is used as a slidable member such as a seal ring.

Priority is claimed to Japanese Patent Application No. 2003-420163 filed on Dec. 17, 2003, the disclosure of which is incorporated by reference in its entirety.

### BACKGROUND OF THE INVENTION

1. Field of the Invention

The present invention relates to a porous ceramic sintered body for slidable member such as a seal ring used in a mechanical seal that is a shaft sealing device of a refrigerator etc, and a manufacturing method thereof, as well as a seal ring.

2. Description of Related Art

A seal ring used in a mechanical seal is taken as an example of porous ceramic sintered bodies for slidable member.

The mechanical seal is one of shaft sealing devices of fluid machinery for the purpose of complete fluid sealing of rotating parts of various machines, and functions to restrict the leakage of fluid at a sealing end surface substantially vertical to a rotation axis. The mechanical seal consists of a driven ring movable axially in accordance with the wear of the sealing end surface, and an immovable seat ring.

Its basic structure is shown in FIG. 1. The seal ring is attached to between a rotation axis 1 and a casing 2. A sealing end surface 3, on which sealing operation is exerted, is composed of mating surfaces of a seat ring 5 as a stationary member, and a driven ring 6 as a rotating member. The sealing end surface 3 forms a perpendicular plane to the rotation axis 1 thereby to perform sealing operation. The driven ring 6 is supported in such a manner as to be buffered by packing 7, and does not contact with the rotation axis 1.

A collar 9 is engaged to the rotation axis 1, and fixed to the rotation axis 1 by a setscrew 10. A coil spring 8 is interposed between the collar 9 and the packing 7. The driven 6 and the collar 9 are engaged each other to prevent relative rotation therebetween, thereby permitting axial movement of the driven ring 6.

Both of the side end surface of the seat ring 5 and the side end surface of the driven ring 6 are substantially perpendicular to the shaft line of the rotation axis 1, and by lapping, these surfaces are reduced in surface-roughness such that flatness is maintained at a high degree so as to constitute a sealing end surface 3.

Sealing fluid contacts with the outer periphery of the sealing end surface 3, and the atmosphere contacts with the inner periphery. The sealing end surface 3 is enhanced in the magnitude of contact pressure by the elastic force of the coil spring 8. A cushion rubber 4 cushions and supports the sheet ring 5, and also prevents leakage between the driven ring 6 and the rotation axis 1. The sealing end surface 3 prevents leakage between the respective end surfaces formed by the seat ring 5 and the driven ring 6. As the rotation axis 1 rotates, the collar 9 rotates together. The collar 9 rotates the driven ring 6. The packing 7 and the coil spring 8 rotate together.

Since the sheet ring 5 does not rotate, the sealing end surface 3 becomes the mating surface of a relatively rotating surface thereby to prevent leakage of sealing fluid even when the rotating axis 1 rotates. As the sealing end surface 3 wears by friction, the driven ring 6 is forced toward the sheet ring 5, so that the sealing end surface 3 is kept tight. The cushion rubber 4 and the packing 5 mitigate transfer of vibration of the rotation axis 1 to the sealing end surface 3.

The mechanical seal is established with the foregoing structure. In general, however, the above-mentioned sheet ring 5 and the driven ring 6 are termed “seal ring.”

As a member for seal ring used herein, carbon material, hard metal, silicon carbide sintered body, and alumina sintered body are used mainly. Silicon carbide sintered bodies, which have high hardness, high corrosion resistance, a small friction factor during slide, and excellent smoothness, come into increasing use in the recent years.

Among such silicon carbide sintered bodies, porous silicon carbon sintered bodies are now arousing interest, wherein pores are formed with pore forming material in the step of manufacturing a dense silicon carbide sintered body, in order to further improve sliding property.

Specifically, the description of U.S. Pat. No. 5,395,807 and the description of U.S. Pat. No. 5,834,387 disclose seal rings of silicon carbide sintered body in which independent pores having a porosity in the range of 2 to 12 volume %, and a mean pore diameter in the range of 50 to 500 μm are formed by using cross-linked polystyrene beads as pore forming material.

Japanese Patent Publication No. 05-69066 discloses a seal ring of silicon carbide, in which independent pores having a porosity in the range of 3 to 13 volume %, and a mean pore diameter in the range of 10 to 40 μm are formed by using emulsion-polymerized polystyrene beads as pore forming material.

In the sintering of the seal rings disclosed in these prior art, solid sintering is employed mainly, and boron carbide and carbon are used as sintering additive thereof. Polyvinyl alcohol and polyethylene glycol etc. are often employed as the forming aid used in a manufacturing method for obtaining the above-mentioned ceramic sintered body.

In almost all of the above-mentioned porous ceramic sintered bodies for slidable member, the porosity in a ceramic sintered body is set, as a real product, to not more than 13 volume %, in order to ensure necessary strength as a slidable member. However, to further improve sliding property for slidable member, it is desirable to set the porosity in a ceramic sintered body to a high value.

In this case, the use of pore forming material for the purpose of forming pores is accompanied by an increase in the amount of addition of the pore forming material.

However, as described in the forgoing prior art, the manner of using cross-linked polystyrene beads and emulsion-polymerized polystyrene beads as pore forming materials, suffers from the following problem. That is, the elastic recovery of a green body becomes extremely large at the time of forming a powder raw material, which is obtained by blending ceramic powder, forming aid and pore forming material, and the coefficient of thermal expansion of the green body increases at the stage of sintering the green body. As a result, cracks occur in the ceramic green body in contact with the pore forming material, and hence the cracks remain in the after-sintering product. This leads to deterioration of strength so that the product is substantially worthless.

Further, for the purpose of reducing the manufacturing cost, the green body obtained from the above-mentioned mixed powder material requires high strength of the green body in order to avoid deterioration of yield, and excellent mold releasability property in order to permit a long range continuous forming.

### SUMMARY OF THE INVENTION

The present invention aims at providing easily at low prices a high-quality porous ceramic sintered body for slidable member, which ensures necessary strength as a slidable member such as a seal ring, and which is excellent in sliding property and free of cracking and chipping.

A porous ceramic sintered body for slidable member of the present invention is obtained by forming bubbles by removing organic matter from a ceramic green body containing ceramic powder, forming aid, and pore forming material that is resin beads selected from suspension-polymerized non-cross-linked polystyrene and suspension-polymerized non-cross-linked styrene-acryl copolymer, followed by heating and sintering. The mean pore diameter is 20 to 39 μm, and the porosity is over 13.0 volume % and not more than 18.0 volume %. The aforesaid ceramic powder is silicon carbide powder, for example.

A porous silicon carbide sintered body of the present invention contains silicon carbide as the main component, aluminum compound of not more than 11% by weight to 100% by weight of the silicon carbide, rare-earth element compound of not more than 15% by weight to 100% by weight of the silicon carbide, and silicon oxide of not more than 8% by weight to 100% by weight of the silicon carbide. The porous silicon carbide sintered body has a mean pore diameter of 20 to 39 μm, and a porosity of over 13.0 volume % and not more than 18.0 volume %.

A method of manufacturing a porous silicon carbide sintered body for slidable member in accordance with the present invention includes: the step of obtaining powder raw material by mixing ceramic powder, forming aid, and pore forming material that is resin beads selected from suspension-polymerized non-cross-linked polystyrene and suspension-polymerized non-cross-linked styrene-acryl copolymer; the step of obtaining a ceramic green body by forming the powder raw material; and the step of obtaining a ceramic sintered body by forming bubbles by removing organic matter from the ceramic green body, followed by heating and sintering.

A method of manufacturing a porous silicon carbide sintered body for slidable member in accordance with the present invention includes: the step of obtaining a ceramic green body by forming, in a predetermined shape, raw material obtained by mixing together silicon carbide as the main component, aluminum compound of not more than 11% by weight to 100% by weight of the above silicon carbide, rare-earth element compound of not more than 15% by weight to 100% by weight of the above silicon carbide, silicon oxide of not more than 8% by weight to 100% by weight of the above silicon carbide, pore forming material for forming pores, and forming aid; and the step of sintering after forming bubbles by removing organic matter from the ceramic green body. The green body after forming bubbling and before sintering has a residual carbon rate of 0.5 to 3.0%.

In accordance with the present invention, by virtue of high porosity exceeding 13.0 volume %, sliding property can be improved to obtain a high-quality porous ceramic sintered body, free of cracks, etc. Further, in accordance with the method of the present invention, excellent productivity is also attainable, in addition to excellent sliding property and high strength. This enables to provide easily at low prices a high-quality porous ceramic sintered body for slidable member, free of cracks, etc.

The porous ceramic sintered body of the present invention becomes slidable members of high reliability and long life by applying it to seal rings in mechanical seals, further to seal rings for motor cooling-water pumps, etc.

### BRIEF DESCRIPTION OF THE DRAWINGS

FIG. 1 is a sectional view illustrating a basic structure of a mechanical seal using a porous ceramic sintered body for slidable member of the present invention.

### DESCRIPTION OF PREFERRED EMBODIMENTS

<First Preferred Embodiment>

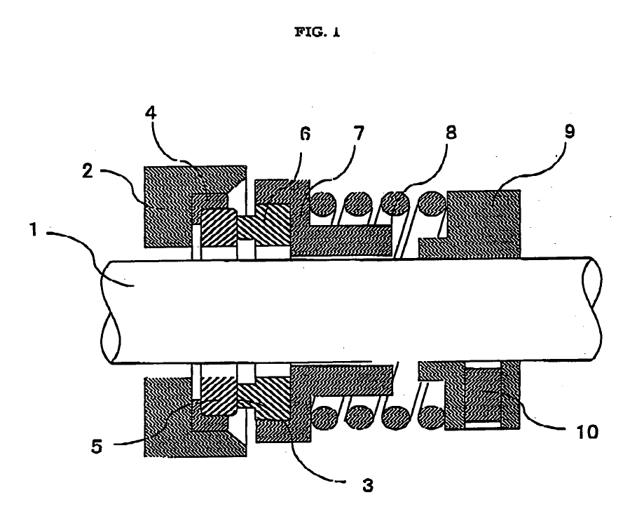

FIG. 1 shows a basic structure of a mechanical seal, which is one of shaft devices of fluid machinery aimed at complete fluid sealing of rotating parts of various machines. The center section of this mechanical seal consists of the sheet ring 5 and the driven ring 6, as described in the prior art, and a combination of the two is termed seal ring.

In the present invention, the resin beads composed of suspension-polymerized non-cross-linked polystyrene or suspension-polymerized non-cross-linked styrene-acryl copolymer is used as the pore forming material for forming bubbles in a ceramic sintered body employed as a slidable member, like this seal ring. Thereby, even if the porosity of a ceramic sintered body is set to a high value, neither of cracks and chips occurs, thus leading to a porous ceramic for slidable member having excellent sliding property and high strength.

This is to utilize the feature that the resin beads composed of suspension-polymerized non-cross-linked polystyrene or suspension-polymerized non-cross-linked styrene-acryl copolymer, which is used as the pore forming material, is low in elastic recovery, and the coefficient of thermal expansion is low in the temperature range until they are dissolved. As a result, the green body obtained by forming powder raw material, which is obtained by mixing together the above-mentioned pore forming material, the ceramic powder and the forming aid, has a low elastic recovery rate and a low coefficient of thermal expansion, thus permitting a high-quality porous ceramic sintered body, free of cracks, etc.

The aforesaid effect is remarkable, especially when the amount of addition of pore forming material is in the range of 7 to 11% by weight to 100% by weight of a total of ceramic powder and forming aid. When the elastic recovery rate of a green body is. over 0.7%, and when the coefficient of thermal expansion of a green body is over 0.7%, cracks occur at ceramic portions, leading to deterioration of strength.

As disclosed in, for example, U.S. Pat. No. 5,395,807 and Japanese Patent Publication No. 05-69066, in a case where cross-linked polystyrene beads and emulsion-polymerized polystyrene beads are used, as pore forming material, by adding a great deal of pore forming material for the purpose of setting a high porosity, the elastic recovery rate of the green body exceeds 0.7%, and the coefficient of thermal expansion also exceeds 0.7%, thus causing the problem that cracks occur at ceramic portions, and the strength is deteriorated.

Hence, it is extremely effective to use resin beads composed of suspension-polymerized non-cross-linked polystyrene or suspension-polymerized non-cross-linked styrene-acryl copolymer, as the pore forming material for obtaining a porous ceramic sintered body for slidable member, which is free of cracks, etc., and excellent in sliding property.

The elastic recovery rate of the green body as described herein is to be defined by the rate of the dimension immediately after pressure release of that formed under a pressure of 1 ton/cm², and the dimension after an elapse of sufficient time. The coefficient of thermal expansion is based on JIS-R-1618-1994, and confirmed by measuring the amount of extension of a green body in the range of from room temperature to 600° C.

Relating to a porous ceramic sintered body for slidable member, it is effective to use silicon carbide powder as ceramic powder, for the purpose of improving sliding property. Sintering additive for obtaining this silicon carbide sintered body is preferably at lease one selected from aluminum oxide, rare-earth element oxide and silicon oxide, in order to improve strength. The amount of addition of these sintering additives is preferably 1 to 15% by weight to 100% by weight of ceramic powder.

When the amount of addition of sintering additive exceeds 15% by weight, the formation of liquid phase increases at the stage of sintering, and decomposition and evaporation becomes violent. There may arise the problem that the strength of sintered body deteriorates due to the occurrence of fine bubbles, and hence it is difficult to maintain the formed shape. When the amount of addition of sintering additive is below 1% by weight, the liquid phase formation is insufficient and densification is impaired, thus leading to deterioration of strength.

To avoid these problems, it is further preferable to set such that aluminum compound is 1.0 to 6.0% by weight, rare-earth element compound is 0.1 to 5.0% by weight, and silicon oxide is 0.1 to 4.0% by weight.

Relating to the forming aid for obtaining a ceramic sintered body, it is effective to use together glycerin, acrylic resin, and sorbitan ester of fatty acid.

Glycerin improves the plasticity of a green body and has the effect of preventing deterioration of the strength of a sintered body. Acrylic resin has the effect of preventing cracks of a green body because it has toughness whereas improving the strength of the green body. Sorbitan ester of fatty acid has the effect of improving mold releasability between a green body and a metal mold at the time of forming. Accordingly, a combination of these compositions makes possible to obtain a ceramic sintered body, which causes neither of deterioration of sintered body strength due to the occurrence of fine pores and deterioration of yield due to lack of green body strength, and which is excellent in productivity because of the improved mold releasability during forming. In contrast, the above-mentioned effects cannot be so expected when using polyvinyl alcohol and polyethylene glycol etc., as is well known.

On the other hand, when the amount of addition of forming aid is below 3% by weight, deterioration of yield due to lack of green body strength might occur. When it exceeds 10% by weight, a sintered body might cause cracks by rapid volume expansion due to the gasification of forming aid composition in the step of forming bubbles by removing organic matter from a ceramic green body. Hence, the amount of addition of forming aid is preferably in the range of 3 to 10% by weight to 100% by weight of ceramic powder. The proportions of glycerin, acrylic resin and sorbitan ester of fatty acid can be set arbitrarily, depending on the product shape.

Relating to the pores of a ceramic sintered body, the porosity of pores is over 13.0 volume % and not more than 18.0 volume %, preferably 14 to 17 volume %, for the purposes of improving sliding property and preventing deterioration of strength. The mean pore diameter of the pores is preferably in the range of 20 to 39 μm. When porosity is not more than 13 volume %, the sliding property tends to deteriorate. When porosity exceeds 18 volume %, deterioration of strength may occur.

When the mean pore diameter is below 20 μm, the lubrication effect of lubrication liquid may diminish. When the mean pore diameter is over 39 μm, the necessary strength of a seal ring etc. cannot be retained. The mean pore diameter described herein is obtained as follows. After taking a metallographical microscope photograph or an SEM photograph of the minor finished surface of a sintered body, pores formed by adding pore forming material are specified on the photograph, and then the diameters of the respective pores are measured, and a mean value is calculated. The porosity is found by calculating the rate of theoretical density in a sintered body composition and the bulk density of the obtained sintered body.

The mean aspect ratio of crystals constituting a ceramic sintered body is preferably not more than 3. When the mean aspect ratio is over 3, the crystal shape becomes a plate-like and then three-dimensional network structure. It follows that a great number of fine pores other than the pores formed by adding pore forming material are present in a ceramic sintered body, thus leading to deterioration of the sintered body strength.

The mean aspect ratio of crystals described herein is obtained by performing chemical etching of the mirror finished surface of a sintered body; taking its metallographical microscope photograph or its SEM photograph; determining the ratio of a longer side of each crystal and a shorter side crossing at right angles to a position at which the longer side is divided into two; and calculating its mean value.

A method of manufacturing a porous ceramic sintered body for slidable member will next be described by taking a porous silicon carbide sintered body as example.

First, to silicon carbide powder containing a trace quantity of silica as starting material, alumina powder and yttria powder and water are mixed to produce a slurry. To this slurry, glycerin, acrylic resin and sorbitan ester of fatty acid are added and mixed as forming aid, and then spray drying is performed to prepare granulating powder. This granulating powder and resin beads consisting of suspension-polymerized non-cross-linked polystyrene or suspension-polymerized non-cross-linked polystyrene styrene-acryl copolymer as pore forming material are mixed to prepare raw material powder.

This raw material powder is formed into a predetermined shape, and put into a vacuum furnace. Under an atmosphere of nitrogen, the temperature is elevated to from 450 to 650° C. in 10 to 40 hours, and held at 450 to 650° C. for 2 to 10 hours, followed by self-cooling.

This powder green body is further sintered in a vacuum furnace at temperatures of 1800 to 1900° C. under an atmosphere of argon. The obtained sintered body is processed into a predetermined shape thereby to manufacture a slidable member of a seal ring, or the like.

The sintered body manufactured by the foregoing manufacturing method has high porosity and ensures not less than 200 MPa in four-point bending strength, which is necessary strength measure as a slidable member of a seal ring, etc. In addition, the product is free of cracking and chipping, and a high quality one having excellent sliding property and excellent productivity. Four-point bending strength is measured by JIS Standard (C2141-1992).

Accordingly, it is very suitable to use the obtained sintered body in a motor cooling-water pump for which high strength and excellent sliding property are required. Besides seal rings, the above-mentioned sintered body can also be used effectively as a slidable member, such as bearing members, faucet members and pump members.

<Second Preferred Embodiment>

In accordance with a second preferred embodiment, a silicon carbide sintered body, whose porosity is over 13 volume %, can maintain 200 MPa in four-point bending strength that is necessary strength measure as a seal ring, by using silicon carbide as the main composition of a silicon carbide sintered body constituting a seal ring; containing, as sintering additive, not more than 11% by weight of aluminum compound, not more than 15% by weight of rare-earth element compound, and not more than 8% by weight of silicon oxide, to 100% by weight of silicon carbide; and setting a mean pore diameter of pores to a range of 20 to 39 μm.

This utilizes the fact that the use of the above-mentioned materials as the sintering additive of silicon carbide can generate mainly liquid phase sintering, thereby to lower sintering temperature and produce the effect of improving strength.

Such strength improving effect and the setting of mean pore diameter to the range of 20 to 39 μm enable to set to a high porosity over 13 volume %. At the same time, the reduction of friction when a seal ring slides, and the lubrication effect of lubricant liquid are facilitated, thus leading to improvement of sliding property.

For example, when the respective amounts of aluminum compound, rare-earth element compound and silicon oxide, which are used as the sintering additives for obtaining a silicon oxide sintered body, exceed their respective ranges as described above, liquid phase generation at the stage of sintering may increase, and decomposition and evaporation becomes violent. Hence, there may arise the problem that strength is lowered due to the occurrence of fine pores, and the formed shape cannot be retained. In contrast, when the amounts of the above-mentioned components are extremely small, liquid phase generation is insufficient thereby to impair densification, leading to deterioration of strength.

Accordingly, it is preferable to use, as sintering additive, aluminum compound in the range of 1.0 to 6.0% by weight, rare-earth element compound in the range of 0.1 to 5.0% by weight, and silicon oxide in the range of 0.1 to 4.0% by weight.

Examples of impurities other than these compositions are metals such as iron and titan or their compounds, and carbon. Since these impurities may impair densification and deteriorate strength, they are preferably not more than 2% by weight.

Porosity is over 13.0 volume % and not more than 18.0 volume %, preferably 14 to 17 volume %.

To obtain a silicon carbide sintered body whose porosity exceeds 13 volume %, it is necessary to prepare silicon carbide powder, to which organic matter such as pore forming material and binder are added. When this powder is merely formed and sintered, there may arise the problem that the product has cracks and chips, and hence the product is substantially worthless.

Therefore, the step of removing organic matters and forming bubbles is added after the formation of silicon carbide powder, to which organic matters such as pore forming material and forming aid (such as binder) are added. The residual carbon rate of the powder green body obtained in the step of forming bubbles is adjusted to the range of 0.5 to 3.0% by weight, and then sintered. Thereby, although porosity exceeds 13 volume %, the necessary strength for slidable member is retained to provide a porous silicon carbide sintered body, which is a sintered body excellent in sliding property and free of chipping during product handling and cracks during sintering.

Accordingly, it is also important to add the step of removing organic matters and forming bubbles prior to the step of sintering powder sintered body, and sinter after adjusting the residual carbon rate of the powder green body subjected to the step of forming bubbles, to the range of 0.5 to 3.0% by weight. By setting the residual carbon rate to the above-mentioned range, it is able to obtain the effect of preventing rapid volume expansion due to the gasification of organic matter dissolved in the step of forming bubbles, while holding the minimum strength for maintaining the shape of a powder green body. This enables to easily provide a high-quality slidable member free of cracking and chipping.

As the aforesaid pore forming material, various resin beads conventionally used as pore forming material such as fine acryl beads (acrylic resin beads) are usable, besides the same resin beads as the foregoing first preferred embodiment.

As the aforesaid forming aid, the same forming aid as the first preferred embodiment can be exemplified. Alternatively, only binder material such as acrylic resin may be used.

To adjust the residual carbon rate to the aforesaid range, it is effective to specify a maximum retaining temperature, temperature elevating time, and the atmosphere within a furnace up to the maximum retaining temperature.

If the residual carbon rate after the step of forming bubbles is below 0.5% by weight, the strength of a powder green body is lowered, and hence there is a good chance that the product shape may not be retained and chipping may occur during handling.

On the other hand, if the residual carbon rate exceeds 3.0% by weight, cracks occur by rapid volume expansion due to gasification when the added organic matter is dissolved in the succeeding step of sintering. This results in a great drop in product yield, as described above.

The residual carbon rate described herein can be calculated as follows. A weight reduction rate is given by: subtracting the weight after forming bubbles from the weight of a powder green body prepared for obtaining the aforesaid porous silicon carbide sintered body; and subtracting the weight reduction rate from the proportions of addition of binder contained in the powder green body and organic compounds for forming pores.

The following is a method for manufacturing a porous silicon carbide sintered body for slidable member in accordance with the present invention.

First, to silicon carbide powder containing a trace quantity of silica as starting material, alumina powder and yttria powder and water are mixed to produce a slurry. To this slurry, binder and pore forming material (e.g. fine acryl beads) are added and mixed, and then spray drying is performed to prepare granulating powder. This granulating powder is formed into a predetermined shape, and put into a vacuum furnace. The temperature is elevated to 450 to 650° C. in 10 to 40 hours, and held at 450 to 650° C. for 2 to 10 hours, followed by self-cooling.

Herein, the powder green body, whose retaining carbon rate is adjusted to the range of 0.5 to 3.0% by weight, is further sintered in the vacuum furnace at temperatures of 1800 to 1900° C. under an atmosphere of argon. The obtained sintered body is processed into a predetermined shape, thereby manufacturing a slidable member of a seal ring, or the like.

The slidable member manufactured in the foregoing manufacturing method can be a high-quality product having excellent sliding property, which has a porosity over 13 volume %, and ensures necessary strength measure of 200 MPa, and which is free of cracking and chipping.

Otherwise, the method is the same as the foregoing first preferred embodiment, and therefore the overlapping description is omitted herein. In particular, mean pore diameter and porosity are obtainable in the same manner as described in the foregoing preferred embodiment.

The following examples illustrate the manner in which the present invention can be practiced. It is understood, however, that the examples are for the purpose of illustration and the invention is not to be regarded as limited to any of the specific materials or condition therein.

### EXAMPLES

### Example 1

To 100% by weight of silicon carbide powder containing 0.5% by weight of silica, 3.7% by weight of alumina powder and 0.6% by weight of yttria powder as sintering additive, 122% by weight of water, and 0.3% by weight of aqueous ammonia as dispersing agent, and 84% by weight of urethane balls were put in a ball mill, and mixed for 48 hours to produce a slurry.

To this slurry, as forming aid, 2.0% by weight of glycerin, 4.0% by weight of acrylic resin and 1.8% by weight of sorbitan ester of fatty acid were added and mixed, and then spray drying was performed to prepare granulating powder.

Subsequently, to 100% by weight of this granulating powder, pore forming materials, which are of the type and have the rate of addition as indicated in Table 1, were added and mixed to prepare a mixed raw material. This mixed raw material was formed in a predetermined shape under a pressure of 1 ton/cm².

Relating to the obtained powder green body, its elastic recovery rate was calculated from the dimension immediately after forming and the dimension after an elapse of 300 hours, and its coefficient of thermal expansion was measured from room temperature to 600° C. in the measuring method based on JIS-R-1618-1994. The cracks of the green body were also observed. The results are shown in Table 1.

Thereafter, in the obtained powder green body, pores were formed under the conditions that it was elevated to from 450 to 650° C. in 10 to 40 hours, and held at 450 to 650° C. for 2 to 10 hours, in an atmosphere of nitrogen within a vacuum furnace, followed by self-cooling. The resulting powder green body was sintered at temperatures of 1800 to 1900° C. in an atmosphere of argon within a vacuum furnace, thereby obtaining a sintered body.

The obtained sintered body was evaluated as to porosity, four-point bending strength, and cracks. The results are shown in Table 1.

TABLE 1

| | | | Mean Particle | | |
|---|---|---|---|---|---|
| | | Amount of | Diameter of | Elastic | Coefficient of |
| | | Pore Forming | Pore Forming | Recovery of | Thermal |
| Sample | Kinds of Pore Forming | Materials | Material | Green Body | Expansion of |
| No. | Material | (% by weight) | (μm) | (%) | Green Body (%) |
| I-1 | Suspension-polymerized | 5 | 39 | 0.2 | 0.1 |
| I-2 | Non-cross-linked | 8 | | 0.2 | 0.2 |
| I-3 | Polystyrene | 11 | | 0.5 | 0.4 |
| I-4 | Suspension-polymerized | 5 | | 0.2 | 0.1 |
| I-5 | Non-cross-linked | 8 | | 0.3 | 0.1 |
| I-6 | Styrene-acryl Copolymer | 11 | | 0.5 | 0.4 |
| * I-7 | Emulsion-polymerized | 5 | | 0.6 | 0.7 |
| * I-8 | Cross-linked Polystyrene | 8 | | 0.7 | 1.9 |
| * I-9 | | 11 | | 0.9 | 2.3 |

| | | | Four-point | | |
|---|---|---|---|---|---|
| | Generation of | | Bending | Generation of | |
| Sample | Cracks in | Porosity | Strength | Cracks in | |
| No. | Green Body | (volume %) | (MPa) | Sintered Body | Evaluation |
| I-1 | No | 9.0 | 310 | No | Δ |
| I-2 | No | 14.3 | 239 | No | ∘ |
| I-3 | No | 17.1 | 212 | No | ∘ |
| I-4 | No | 9.3 | 299 | No | Δ |
| I-5 | No | 14.1 | 242 | No | ∘ |
| I-6 | No | 17.1 | 210 | No | ∘ |
| * I-7 | No | 8.9 | 303 | No | Δ |
| * I-8 | No | 14.5 | 197 | Yes | x |
| * I-9 | Yes | 17.4 | 142 | Yes | x |

Samples indicated as * are out of the scope of the present invention.

The followings are apparent from Table 1. In all the samples in which suspension-polymerized non-cross-linked polystyrene and non-cross-linked styrene-acryl copolymer of the present invention are used as pore forming material, regardless of the amount of addition of the pore forming materials, both of the elastic recovery rate and the coefficient of thermal expansion of the green body are as low as not more than 0.7%, and the strength is not less than 200 MPa, which is necessary strength as a slidable member such as a seal ring. No crack is observed in both of the molding body and the sintered body.

In Sample No. I-1 and Sample No. I-4, however, the porosity is not more than 13% by weight. From the viewpoint of sliding property, these are inferior to other samples.

On the other hand, in the sample in which emulsion-polymerized cross-linked polystyrene, not employed in the present invention, is used as pore forming material, and the amount of addition of the pore forming material is 5% by weight, both of the elastic recovery rate and the coefficient of thermal expansion of the green body are as low as not more than 0.7%. No crack is observed in both of the green body and the sintered body, and four-point bending strength exceeds 200 MPa. However, porosity is not more than 13% by weight, resulting in poor sliding property.

When the amount of addition of pore forming material exceeds 8% by weight, it is observed that the molding body has a large value in elastic recovery rate and in efficient of thermal expansion, and therefore cracks occur to deteriorate strength.

In Sample No. I-8, the elastic recovery rate of the green body is not more than 0.7%, and no crack is observed in the green body, but cracks are observed in the sintered body.

In other words, the coefficient of thermal expansion of the green body is as high as 1.9%, and hence cracks occur at the low temperature stage in the sintering process.

Accordingly, to avoid cracks, it is an effective technique to control both of the coefficient of thermal expansion of the green body and the elastic recovery rate to not more than 0.7%.

Thus, it can be confirmed that an effective manufacturing method for obtaining a high-quality porous ceramic sintered body for slidable member, which has excellent sliding property, holds strength of not less than 200 MPa, and is free of cracks, etc., is attainable by using suspension-polymerized non-cross-linked polystyrene or suspension-polymerized non-cross-linked styrene-acryl copolymer as pore forming material, and controlling the elastic recovery rate and the coefficient of thermal expansion of the green body to not more than 0.7%.

### Example II

To 100% by weight of silicon carbide powder containing 0.5% by weight of silica, 3.7% by weight of alumina powder and 0.6% by weight of yttria powder as sintering additive, 122% by weight of water, and 0.3% by weight of aqueous ammonia as dispersing agent, and 84% by weight of urethane balls were put in a ball mill, and mixed for 48 hours to produce a slurry.

To this slurry, forming aids, the types and the amounts of addition of which are as indicated in Table 2, were added and mixed, and then spray drying was performed to prepare granulating powder.

Subsequently, to 100% by weight of this granulating powder, 8% by weight of resin beads as pore forming material, which is composed of suspension-polymerized non-cross-linked styrene-acryl copolymer and has a mean particle diameter of 39 μm, was added and mixed to prepare a mixed raw material.

This mixed raw material was formed in a predetermined shape under a pressure of 1 ton/cm². The forming shot number, with which the raw material adhesion to the metal mold is started, the green body strength, and cracks were evaluated. The results are shown in Table 2.

Thereafter, in the obtained powder green body, pores were formed under the conditions that it was elevated to from 450 to 650° C. in 10 to 40 hours, and held at 450 to 650° C. for 2 to 10 hours, in an atmosphere of nitrogen within a vacuum furnace, followed by self-cooling. The resulting powder green body was sintered at temperatures of 1800 to 1900° C. in an atmosphere of argon within a vacuum furnace, thereby obtaining a sintered body. The obtained sintered body was evaluated as to porosity, four-point bending strength, and cracks. The results are shown in Table 2.

TABLE 2

| | Kinds and Amount of Forming Aid | | | | | |
|---|---|---|---|---|---|---|
| | | | Sorbitan Ester | Polyvinyl | Polyethylene | Green Body |
| Sample | Glycerin | Acryl Resin | of Fatty acid | Alcohol | Glycol | Strength |
| No. | (% by weight) | (% by weight) | (% by weight) | (% by weight) | (% by weight) | (gf/mm²) |
| II-1 | 0.5 | 0.5 | 0.2 | — | — | 104 |
| II-2 | 0.5 | 2.0 | 0.5 | — | — | 161 |
| II-3 | 2.0 | 4.0 | 1.8 | — | — | 171 |
| II-4 | 2.5 | 6.0 | 1.5 | — | — | 192 |
| II-5 | 3.0 | 6.0 | 3.0 | — | — | 210 |
| II-6 | — | — | — | 6.0 | — | 310 |
| II-7 | — | — | — | — | 6.0 | 81 |
| II-8 | — | — | — | 1.0 | 5.0 | 102 |

| | Forming Shot | | | | | |
|---|---|---|---|---|---|---|
| | Number, with | | | | | |
| | which the raw | Generation | | Four-point | Generation | |
| | material adhesion | of Cracks | | Bending | of Cracks | |
| Sample | is started | in Green | Porosity | Strength | in Sintered | |
| No. | (punches) | Body | (volume %) | (MPa) | Body | Evaluation |
| II-1 | 400 | No | 13.9 | 232 | No | Δ |
| II-2 | 10000 | No | 14.3 | 235 | No | ∘ |
| II-3 | ≧20000 | No | 14.1 | 242 | No | ∘ |
| II-4 | ≧20000 | No | 14.3 | 233 | No | ∘ |
| II-5 | ≧20000 | No | 14.9 | 178 | Yes | x |
| II-6 | 350 | No | 15.4 | 197 | No | x |
| II-7 | 10 | Yes | 13.1 | 191 | Yes | x |
| II-8 | 150 | No | 13.9 | 255 | No | Δ |

The followings are apparent from Table 2. In all the samples in which glycerin, acryl resin and sorbitan ester of fatty acid in the present invention were used together as pore forming material, and these total amount of addition was 3 to 10% by weight, it is observed that no crack occurs in the green body and the sintered body, and the strength is not less than 200 MPa, which is necessary strength as a slidable member such as a seal ring. In Sample No. II-1, it can be expected that the yield might be lowered due to cracking and chipping, because the green body strength is low due to insufficient total amount of the forming aids; and that the productivity is poor due to a small value in the forming shot number, with which the raw material adhesion is started. In Sample No. II-5, the total amount of forming aid exceeds 10% by weight, and by rapid volume expansion due to the gasification of the forming aid compositions at the sintering stage, cracks occur to deteriorate the sintered body strength.

In Sample No. II-2 to Sample No. II-4, the green body strength indicates sufficient values, at which no deterioration of yield occurs. The forming shot number is not less than 10000 punches, and no raw material adhesion to the metal mold is observed. Hence, there is little need of cleaning the metal mold, thus leading to excellent productivity.

On the other hand, in the samples in which polyvinyl alcohol and polyethylene glycol were used as forming aid, it is observed that, due to hard powder granules prior to forming and poor wettability, a great number of fine pores are present after sintering, thereby causing deterioration of strength. There is also the disadvantage that due to extremely soft powder granules prior to forming, the green body strength is lowered to cause cracks.

In addition, due to a small value in the forming shot number, with which the raw material adhesion is started, the productivity in the forming process cannot be expected.

Thus, it can be conformed that an effective manufacturing method for obtaining a high-quality porous ceramic sintered body for slidable member, which has excellent sliding property, holds strength of not less than 200 MPa, has excellent productivity, and is free of cracking and chipping etc., is attainable by using together glycerin, acrylic resin and sorbitan ester of fatty acid as forming aids, and controlling the total amount of addition to the range of 3 to 10% by weight.

### Example III

To 100% by weight of silicon carbide powder containing 0.5% by weight of silica, alumina powder and yttria powder as sintering additives, which have the respective rates as indicated in Table 3; 122% by weight of water; 0.3% by weight of aqueous ammonia as dispersing agent; and 84% by weight of urethane balls were put in a ball mill and mixed for 48 hours to produce a slurry.

To this slurry, 2.0% by weight of glycerin and 4.0% by weight of acrylic resin and 1.8% by weight of sorbitan ester of fatty acid as forming aids were added and mixed, and then spray drying was performed to prepare granulating powder.

Subsequently, to 100% by weight of this granulating powder, resin beads composed of suspension-polymerized non-cross-linked styrene-acryl copolymer as pore forming material, which has the particle diameter and the rate as indicated in Table 3, was added and mixed to prepare a mixed raw material.

This mixed raw material was formed in a predetermined shape under a pressure of 1 ton/cm², and then pores were formed under the conditions that it was elevated to from 450 to 650° C. in 10 to 40 hours, and held at 450 to 650° C. for 2 to 10 hours, in an atmosphere of nitrogen within a vacuum furnace, followed by self-cooling.

The resulting powder green body was sintered at temperatures of 1800 to 1900° C. in an atmosphere of argon within a vacuum furnace, thereby obtaining a sintered body. The obtained sintered body was evaluated as to porosity, mean pore diameter, four-point bending strength, mean aspect ratio of crystals, and the appearance such as cracks and deformation.

The results are shown in Table 3. Comparative Examples, in which boron carbide and carbon were used as sintering additive, are also indicated in Table 3.

TABLE 3

| | | Mean Particle | | | | |
|---|---|---|---|---|---|---|
| | Amount of | Diameter of | | Rare-earth | | |
| | Pore Forming | Pore Forming | Aluminium | Element | Silicon Oxide | |
| Sample | Materials | Material | Compound | Compound | Compound | Porosity |
| No. | (% by weight) | (μm) | (% by weight) | (% by weight) | (% by weight) | (volume %) |
| III-1 | 6 | 39 | 3.7 | 0.6 | 0.5 | 10.8 |
| III-2 | 7 | 39 | | | | 13.1 |
| III-3 | 8 | 21 | | | | 14.0 |
| III-4 | | 39 | | | | 14.1 |
| III-5 | | 71 | | | | 14.4 |
| III-6 | 11 | 39 | | | | 17.1 |
| III-7 | 12 | 39 | | | | 19.1 |
| III-8 | 8 | 39 | — | — | | 19.3 |
| III-9 | | | 13.0 | 3 | | 15.8 |
| III-10 | | | — | — | — | 14.2 |

0.4% by weight of boron carbide and 2.0%
by weight of carbon were used as
sintering additive.

| | Mean | Four-point | Mean | | |
|---|---|---|---|---|---|
| | Pore | Bending | Aspect | | |
| Sample | Diameter | Strength | Ratio of | Appearance of | |
| No. | (μm) | (MPa) | Crystals | Sintered Body | Evaluation |
| III-1 | 28 | 281 | 2.3 | Cracks, No Deformation | Δ |
| III-2 | 26 | 261 | 2.0 | Cracks, No Deformation | ∘ |
| III-3 | 17 | 265 | 1.9 | Cracks, No Deformation | Δ |
| III-4 | 29 | 242 | 2.1 | Cracks, No Deformation | ∘ |
| III-5 | 47 | 172 | 2.0 | Cracks, No Deformation | Δ |
| III-6 | 26 | 210 | 2.0 | Cracks, No Deformation | ∘ |
| III-7 | 30 | 145 | 2.2 | Cracks, No Deformation | Δ |
| III-8 | 28 | 123 | 1.9 | Cracks, No Deformation | Δ |
| III-9 | 27 | 198 | 2.2 | No Cracks, Deformation | x |
| III-10 | 29 | 161 | 2.2 | Cracks, No Deformation | x |

First, it is apparent from Table 3 that, to obtain a porosity exceeding 13 volume % for the purpose of improving sliding property, it is necessary to add not less than 7% by weight of pore forming material and, at the same time, when the amount of addition is not more than 11% by weight, it is over 200 MPa, which is necessary strength as a slidable member such as a seal ring.

In contrast, when the amount of addition of pore forming material exceeds 12% by weight, it is remarkably observed that the strength is lowered as the porosity is increased. It is therefore apparent that the necessary strength as a slidable member such as a seal ring cannot be retained, as in the solid phase sintered body of Sample No. III-10, indicated as a comparative example.

Relating to mean pore diameter, as described above, deterioration of strength is observed in the range of over 39 μm. It is observed that all the samples have a mean aspect ratio of less than 3.

In addition, when the total amount of addition of aluminum compound, rare-earth element compound and silicon oxide, as sintering additive compositions, is less than 1.0% by weight, deterioration of strength due to insufficient densification is observed. When the total amount of addition is over 15.0% by weight, deformation along with decomposition and evaporation of liquid phase compositions, and deterioration of strength due to the occurrence of fine pores are observed, thus eliminating the practical value as a slidable member such as a seal ring.

Thus, it can be confirmed that an effective manufacturing method for obtaining a high-quality porous ceramic sintered body for slidable member, which has excellent sliding property, holds strength of not less than 200 MPa, and is free of cracking and chipping etc., is attainable by using silicon carbide powder as ceramic powder; containing 1 to 15% by weight of aluminum compound, rare-earth element compound and silicon oxide as sintering additives; adding pore forming material for forming pores in the range of 7 to 11% by weight; and controlling the porosity of pores contained in the sintered body to 13 to 18 volume %, and the mean pore diameter of the pores to 20 to 39 μm, and the mean aspect ratio of crystals to less than 3.

### Example IV

To 100% by weight of silicon carbide powder containing 1% by weight of silica, alumina powder and yttria powder as sintering additive, which have the respective rates as indicated in Table 4; 122% by weight of water; 0.3% by weight of aqueous ammonia as dispersing agent; and 84% by weight of urethane balls were put in a ball mill and mixed for 48 hours to produce a slurry. To this slurry, 8% by weight of binder, of which main composition is acrylic resin, and acryl beads having mean particle diameters of 23 μm, 38 μm, and 69 μm, and having their respective rates as indicated in Table 4, were added and mixed as pore forming materials, and then spray drying was performed to prepare granulating powder.

This granulating powder was formed in a predetermined shape under a pressure of 1 ton/cm², and pores were formed under the conditions that it was elevated to from 450 to 650° C. in 5 to 60 hours, and held at 450 to 650° C. for 2 to 10 hours, in an atmosphere of nitrogen within a vacuum furnace, followed by self-cooling. Thereafter, the decrement of weight was measured to calculate the residual carbon rate. Subsequently, the powder green body, in which the pores were formed, was sintered at temperatures of 1800 to 1900° C. in an atmosphere of argon within a vacuum furnace, thereby obtaining a sintered body. The obtained sintered body was evaluated as to porosity, mean pore diameter, transverse strength (four-point bending strength), and the appearance such as cracks, chips and deformation. The results are shown in Table 4. Comparative Examples, in which silicon carbide and carbon were used as sintering additive, are also indicated in Table 4.

TABLE 4

| | | Mean Particle | | | | |
|---|---|---|---|---|---|---|
| | | Diameter of | | Rare-earth | | |
| | Amount of Pore | Pore Forming | Aluminium | Element | Silicon Oxide | |
| | Forming Materials | Material | Compound | Compound | Compound | Porosity |
| Test No. | (% by weight) | (μm) | (% by weight) | (% by weight) | (% by weight) | (volume %) |
| *IV-1 | 6 | 38 | 3.7 | 0.6 | 1.0 | 10.9 |
| *IV-2 | | | | | | 10.9 |
| *IV-3 | | | | | | 10.5 |
| *IV-4 | 8 | 23 | | | | 13.1 |
| IV-5 | | 38 | | | | 13.8 |
| IV-6 | | | | | | 14.0 |
| IV-7 | | | | | | 13.8 |
| IV-8 | | | | | | 13.9 |
| IV-9 | 10 | 38 | | | | 16.1 |
| IV-10 | | | | | | 16.9 |
| IV-11 | | | | | | 16.8 |
| IV-12 | | | | | | 16.8 |
| IV-13 | | | | | | 16.7 |
| *IV-14 | 12 | 69 | | | | 19.2 |
| *IV-15 | | 38 | | | | 19.1 |
| *IV-16 | | | | | | 18.9 |
| *IV-17 | 8 | 38 | 13.0 | 2.0 | | 15.4 |
| *IV-18 | 8 | 38 | 3.0 | 16.0 | | 15.8 |
| *IV-19 | 8 | 38 | — | — | — | 13.9 |

0.4% by weight of silicon carbide and 2.0%
by weight of carbon were used as
sintering additive.

| | Mean Pore | Residual | | | |
|---|---|---|---|---|---|
| | Diameter | Carbon Rate | Strength | | |
| Test No. | (μm) | (%) | (MPa) | Appearance | Evaluation |
| *IV-1 | 25.9 | 2.9 | 277 | No Cracks | x |
| *IV-2 | 24.8 | 1.0 | 289 | and Chips | x |
| *IV-3 | 25.9 | 0.3 | 301 | Chips | x |
| *IV-4 | 16.0 | 1.8 | 272 | No Cracks | x |
| IV-5 | 25.2 | 2.2 | 244 | and Chips | ∘ |
| IV-6 | 24.7 | 1.5 | 252 | | ∘ |
| IV-7 | 25.1 | 0.8 | 248 | | ∘ |
| IV-8 | 24.8 | 0.3 | 255 | Chips | Δ |
| IV-9 | 24.9 | 3.9 | 211 | Cracks | Δ |
| IV-10 | 26.9 | 2.3 | 223 | No Cracks | ∘ |
| IV-11 | 25.9 | 1.7 | 219 | and Chips | ∘ |
| IV-12 | 26.1 | 1.1 | 220 | | ∘ |
| IV-13 | 26.3 | 0.4 | 216 | Chips | Δ |
| *IV-14 | 45.2 | 1.1 | 127 | No Cracks | x |
| *IV-15 | 32.1 | 1.8 | 132 | and Chips | x |
| *IV-16 | 31.8 | 0.4 | 138 | Chips | x |
| *IV-17 | 26.2 | 1.1 | 188 | Deformation | x |
| *IV-18 | 25.3 | 1.5 | 172 | Deformation | x |
| *IV-19 | 26.5 | 1.9 | 164 | Cracks | x |

Samples indicated as * are out of the scope of the present invention.

It is apparent from Table 4 that, to obtain a porosity exceeding 13 volume %, it is necessary to add not less than 8% by weight of acryl beads as pore forming material. When the amount of addition of the pore forming material is not more than 10% by weight, it is over 200 MPa, which is necessary strength as a member for seal ring.

In contrast, when the amount of addition of acryl beads exceeds 12% by weight, it is remarkably observed that the strength is lowered as the porosity is increased. It is therefore apparent that the necessary strength as a seal ring product cannot be retained, as in the solid phase sintered body of Sample No. IV-19, indicated as a comparative example.

Relating to mean pore diameter, deterioration of strength is observed in the range of over 39 μm, as above described. In Sample Nos. IV-17 and IV-18, in which aluminum compound and rare-earth element compound as sintering additives are beyond the scope of the present invention, the strength is lowered along with the occurrence of fine pores, and deformation occurs along with decomposition and evaporation of liquid phase compositions. Hence, there is no practical value as a seal ring product.

On the other hand, in Sample Nos. IV-1 to IV-16, from the viewpoint of the relationship between residual carbon rate and appearance, when the residual carbon rate is below 0.5%, minimum strength, at which the shape as a powder green body is retainable, cannot be ensured so that bad conditions in appearance such as chips are observed. When the residual carbon rate is over 3.0%, there can be observed bad conditions in appearance, such as cracks along with rapid volume expansion due to the gasification when organic matter is dissolved.

Thus, it can be confirmed that a high-quality porous ceramic sintered body, which has a mean pore diameter in the range of 20 to 39 μm, and holds strength of not less than 200 MPa, while the porosity exceeds 13 volume %, and which is excellent in sliding property and free of cracking and chipping etc., can be obtained by preparing a powder green body, in which 8 to 10% by weight of pore forming material (acryl beads having a mean particle diameter of 38 μm) is added into silicon carbide raw material containing, as sintering additives, not more than 11% by weight of aluminum compound, not more than 15% by weight of rare-earth element compound, and 8% by weight of silicon oxide; adjusting the residual carbon rate to 0.5 to 3.0% by forming bubbles in the powder green body; and sintering.

1. A porous ceramic sintered body for slidable member having a mean pore diameter of 20 to 39 μm, and a porosity exceeding 13.0 volume % and not more than 18.0 volume %, which is obtained by: forming bubbles by removing organic matter from a ceramic green body containing ceramic powder, forming aid, and pore forming material that is resin beads selected from suspension-polymerized non-cross-linked polystyrene and suspension-polymerized non-cross-linked styrene-acryl copolymer; followed by heating and sintering.

2. The porous ceramic sintered body according to claim 1 wherein said ceramic powder is silicon carbide powder.

3. The porous ceramic sintered body according to claim 1 wherein said forming aid is glycerin, acrylic resin and sorbitan ester of fatty acid.

4. The porous ceramic sintered body according to claim 1 further containing, as sintering additive, at least one selected from aluminum compound, rare-earth element compound and silicon oxide.

5. The porous ceramic sintered body according to claim 1 wherein the elastic recovery rate of said ceramic green body is not more than 0.7%.

6. The porous ceramic sintered body according to claim 1 wherein the coefficient of thermal expansion of said ceramic green body is not more than 0.7%.

7. The porous ceramic sintered body according to claim 1 wherein the mean aspect ratio of crystals is not more than 3.

8. The porous ceramic sintered body according to claim 1 wherein four-point bending strength is not less than 200 MPa.

9. A porous silicon carbide sintered body for slidable member containing silicon carbide as main component, aluminum compound of not more than 11% by weight to 100% by weight of said silicon carbide, rare-earth element compound of not more than 15% by weight to 100% by weight of said silicon carbide, and silicon oxide of not more than 8% by weight to 100% by weight of said silicon carbide, a mean pore diameter being in the range of 20 to 39 μm, and a porosity being over 13.0 volume % and not more than 18.0 volume %.

10. The porous ceramic sintered body according to claim 9 wherein aluminum compound is 1.0 to 6.0% by weight, rare-earth element compound is 0.1 to 5.0% by weight, and silicon oxide is 0.1 to 4.0% by weight, to 100% by weight of silicon carbide.

11. A method of manufacturing a porous ceramic sintered body for slidable member comprising the steps of:
obtaining powder raw material by mixing ceramic powder, forming aid, and pore forming material which is resin beads selected from suspension-polymerized non-cross-linked polystyrene and suspension-polymerized non-cross-linked styrene-acryl copolymer;
obtaining a ceramic green body by forming said powder raw material; and
obtaining a ceramic sintered body by forming bubbles by removing organic matter from said ceramic green body, followed by heating and sintering.

12. The method of manufacturing a porous ceramic sintered body according to claim 11 wherein said ceramic powder is silicon carbide powder.

13. The method of manufacturing a porous ceramic sintered body according to claim 11 wherein at least one selected from aluminum oxide, rare-earth element oxide and silicon oxide is added in the range of 1 to 15% by weight to 100% by weight ceramic powder.

14. The method of manufacturing a porous ceramic sintered body according to claim 11 wherein said forming aid comprises glycerin, acrylic resin and sorbitan ester of fatty acid, and is added in the range of 3 to 10% by weight to 100% by weight ceramic powder.

15. The method of manufacturing a porous ceramic sintered body according to claim 11 wherein said pore forming material is blended in the range of 7 to 11% by weight to 100% by weight of a total of said ceramic powder and said forming aid.

16. The method of manufacturing a porous ceramic sintered body according to claim 11 wherein the elastic recovery rate of said ceramic green body is not more than 0.7%.

17. The method of manufacturing a porous ceramic sintered body according to claim 11 wherein the coefficient of thermal expansion of said ceramic green body is not more than 0.7%.

18. A method of manufacturing a porous ceramic sintered body for slidable member comprising the steps of:
obtaining a ceramic green body by forming in a predetermined shape raw material obtained by mixing silicon carbide as main composition, not more than 11% by weight of aluminum compound, not more than 15% by weight of rare-earth element compound, not more than 8% by weight of silicon oxide, pore forming material for forming pores, and forming aid; and
sintering after forming bubbles by removing organic matter from said ceramic green body,
wherein a green body after forming bubbles and before sintering has a residual carbon rate of 0.5 to 3.0%.

19. A seal ring for mechanical seal comprising a porous ceramic sintered body for slidable member according to claim 1 or claim 9.

20. The seal ring according to claim 19, which is used for motor cooling-water pump.
